(19) United States
(12) Patent Application Publication
(10) Pub. No.: US 2010/0146259 A1
(43) Pub. Date: Jun. 10, 2010

(54) MULTI FACTOR AUTHORISATIONS UTILISING A CLOSED LOOP INFORMATION MANAGEMENT SYSTEM

(76) Inventor: Adrian M. Tatham, Australian Capital Territory (AU)

Correspondence Address: ABELMAN, FRAYNE & SCHWAB, 666 THIRD AVENUE, 10TH FLOOR, NEW YORK, NY, 10017, US

(21) Appl. No.: 12/449,164

(22) PCT Filed: Jan. 25, 2008
(86) PCT No.: PCT/AU2008/000121

§ 371 Date: Jan. 14, 2010

(30) Foreign Application Priority Data
Jan. 25, 2007 (AU) 2007900423

(51) Int. Cl. H04L 29/06; H04L 9/00; H04K 1/00

(52) U.S. Cl. 713/152; 713/168; 380/270

(57) ABSTRACT

Methods and Apparatus are disclosed for a multi-factor authentication service which permits customers and account holders to provide secure instructions to entities via their Internet enabled mobile telephone handsets. In preferred embodiments, requests to authorise account holder not present transactions are received from a merchant's terminal (90) and are routed through the bank's proprietary network (95) and the bank's information system (40) through to the Internet (50) and eventually the information management system (20) of the service operator. When the operator receives the request to contact the addressee and obtain instructions it sends out to the addressee an alert message inviting the addressee to log into the information manage system (20) so that the request can be provided and instructions obtained which are eventually routed back to the bank's information system (40) where the instructions are processed. The present invention provides multi-factor authentication. In preferred embodiments the authentication is based on the provision of information tokens, user ID and passwords, post instruction interrogation for pre-registered information, and encryption of information provided during the secure mobile internet sessions in which the request to provide instructions and the provision of instructions occur.

### TECHNICAL FIELD

The methods of the present invention relate to systems and methods for providing multi-factor authentication in respect of instructions to transact or provide information where one party is not present.

### BACKGROUND ART

Through the use of telephones, computers, the Internet, and mobile telephone systems, individuals and businesses have been able to transact with other individuals or businesses through the use of ATM machines, EFTPOS terminals, credit card processing machines, e-commerce sites located on the Internet including HTTP mediated online banking sites and HTTP independent sites such as Apple Inc.'s iTunes store. Further, individuals and businesses have been able to communicate with other individuals or businesses through the use of various technologies including telephone, HTTP communications (e-commerce websites), SMS, email and more recently, wireless technology.

Unfortunately, the rise in popularity of conducting transactions when one party is able to not be physically present, such as in the example of online banking or when a credit cardholder authorises the use of the credit card over the telephone or Internet, has led to a similar rise in the incidence of fraudulent transactions. This rise in fraud has occurred notwithstanding the fact that customers have secret security codes such as PIN numbers and passwords chosen by them for securely conducting transactions.

To date there have been limited technologies dedicated to providing secure environments for online and other transactions when one party is not physically present.

### DISCLOSURE OF THE INVENTION

According to one aspect of the invention, there is provided a secure information management system for accessing sensitive information and conducting transactions comprising a data store and information manager connected to the Internet and a telecommunications network via an Internet server and telecommunications gateway, the information manager being adapted to receive requests to authorise account access or authorise transactions, prepare content containing details of the attempt to authorise account access or transactions, generate information tokens, sending messages to addressee's mobile telephones containing the information tokens and invitations to log into the information management system, receiving from the addressee's mobile telephones information tokens and requests to log into the information management system through a secure mobile internet session, authenticating the addressee based on the provision of an information token that is recorded in the database, providing access to a log in screen, authenticating the addressee on the log in details provided and the information token previously provided, and if the log in details match those contained in the database in association with the information token and the content, providing the addressee with the content, and receiving from the addressees mobile telephone, instructions sent by the addressee in the secure wireless internet session.

Preferably the secure wireless internet session involves an encrypted WAP mediated exchange of WML information over the internet.

Alternatively, the secure wireless internet session involves an encrypted HTTP mediated exchange of HTML information over the internet.

Preferably the information management system is also capable of forwarding the addressee's instruction for processing.

Preferably the information management system is capable of requesting the addressee provide further pre-registered information in response to instructions to transact or provide access to information, the further pre-registered information being required to be provided before the addressee's instructions are on forwarded for processing.

In an alternate preferable embodiment of the invention the information management system is capable of processing the addressee's instructions.

According to a second aspect of the invention there is provided a method for receiving addressee's secure instructions, the method comprising:

an information management system receiving a request;

the information management system creating a content for storage in a database of the information management system relating to the request and containing a request to provide instructions;

the information management system creating an information token to be associated with the content for use as first authentication means, and with the addressee's pre-registered userID and password for use as a second authentication means;

the information management system sending a message to the addressee's registered Internet enabled mobile telephone containing the information token, an alert and an invitation to log into the information management system;

the addressee initiating a secure mobile internet session and providing therein at least the information token;

the information management system authenticating the addressee by querying the database for instances of the information token, and if it is present, presenting the addressee with a login screen for the entry of the addressee's user ID and password;

the information management system providing the addressee access to the content during the secure mobile internet session if the information token provided in the previous step is associated with the at least the user ID, password and the content contained in the database;

the information management system receiving the addressee's instructions provided during the secure mobile internet session and forwarding the instruction on for processing.

Preferably the secure wireless internet session involves an encrypted WAP mediated exchange of WML information over the internet.

Alternatively, the secure wireless internet session involves an encrypted HTTP mediated exchange of HTML information over the internet.

Preferably the request received by the information management system is a request to authorise a transaction or access to information in which the addressee is not physically present.

Preferably the information management system conducts post instruction authentication in which the addressee is requested to provide further pre-registered information, stored in its database, in response to instructions to transact or provide access to information, the further pre-registered information being required to be provided before the addressee's instructions are acted upon.

Preferably the invitation to log into the information management system is contained within a first text message to the mobile telephone.

Preferably the first text message sent to the addressee's mobile telephone comprises a SMS or SI with embedded URL.

Preferably the URL is embedded in the SMS or SI message such that the user does not have to re-enter the URL in the mobile telephones Internet browser in order to log on to the information management system.

Preferably the information token is a unique alphanumeric string and is included in the SMS or SI that contains the invitation to log in via a URL

Preferably the unique alphanumeric string is contained within the URL such that when the URL is requested by the addressee the request to log in sent to the information management system by the addressee's mobile telephone's Internet browser includes the alphanumeric string in it.

Preferably the information management system parses the URL request and extracts the unique alphanumeric string from the request.

Preferably the unique alphanumeric string generated by the information management system can only be used as an authentication means only once and can be made to expire even before it has been used if a certain period of time has elapsed.

Preferably the function of providing the addressee with the details of the proposed transaction or authorisation and the ability to authorise or decline the proposed transaction or authorisation is provided for after the successful secure log into the information management system by the addressee.

Preferably the step of on forwarding the addressee's instruction for processing includes the information management system providing the system which originally requested the transaction or access authorised with the instruction to either accept or decline the transaction or access.

Preferably the steps of receiving from the addressee a request to log into the information management system containing the unique alphanumeric string, requesting at least a username and password from the one or more addressees, providing access to the content, and receiving the addressee's instructions all occur during a secure mobile internet session initiated by the addressee through their mobile telephone.

Preferably the step of receiving the request carried out by the information management system comprises:

forwarding a form to a provider over the Internet, the form having fields for the provider to indicate at least an addressee and a content relating to the event or transaction requiring authorisation;

the information management system being adapted to receive the form completed by the provider, create the content and store it in the information management systems data store, and send the first message to the addressee.

Preferably the form is provided in a web page accessible by web browsers over the Internet such as Internet Explorer, Firefox or Safari.

In a further and alternate preferred embodiment of the invention the content and first message are dynamically constructed by the information management system without further human intervention in response to the receipt of the request containing details of the event or transaction requiring authorisation.

In a further preferred embodiment of the invention, the information management system may provide for a window of time in which the one or more addressee's can access the content.

In a further preferred embodiment of the invention, the information management system may provide for a certain number of times in which the one or more addressee's can access the content.

In a further preferred embodiment of the invention, the information management system may provide that the one or more addressee's can access the content only once.

In a further preferred embodiment of the invention, the wireless device is a mobile telephone with at least SMS and/or SI and WAP/Internet web browser capabilities.

In a further preferred embodiment of the invention, the first message contains an embedded URL which directs the recipient of the message to the login screen of the information management system.

In a further preferred embodiment of the invention the information management system automatically generates content for an addressee in response to the information received by systems connected to the information management system containing requests to process and authorise account holder not present transactions, or other online transactions occurring in which one party is not present.

In a further preferred embodiment of the invention the content automatically generated in response to information received by systems connected to the information management system containing relation to requests to process and authorise account holder not present transactions or other online transactions occurring in which case one party is not present includes details of the requested transaction and a request to provide instructions whether to proceed with the transaction during a secure mobile internet session, and where the instructions provided are routed back the system which provided the original request by the information management system.

In an alternate embodiment of the invention there is provided a method for receiving an addressee's secure instructions, the method comprising:

an information system of a provider receiving a request; the information system of the provider storing the request in a database under the control of the provider's information system;

the information system of the provider forwarding the request to the information management system of an operator;

the information management system of the operator generating an information token for use as first authentication means;

the information management system of the operator generating a content from the contents of the request and associating it with the unique information token and the user ID and password of the addressee;

the information management system of the operator sending a message to the addressee's registered Internet enabled mobile telephone containing the information token, an alert and an invitation to log into the information system of the provider;

the information management system of the operator sending the information token to the provider along with details of the first message sent to the addressee;

the information manager of the provider recording the information token and other details in its database in association with the request;

the addressee providing the information token to the information system of the provider;

the information system of the provider authenticating the addressee by querying the database for instances of the information token, and if it is present, presenting the addressee with a login screen for the entry of second authorisation means comprising the addressee's user ID and password;

the information system of the provider granting the addressee access to the content if the information token provided in the previous step is associated with the at least the user ID, password and the content provided in the second step;

the information system of the provider receiving the addressee's instructions provided and forwarding the instruction on for processing.

Preferably the request received by the information management system is a request to authorise a transaction or access to information in which the addressee is not physically present.

Preferably the information system of the provider conducts post instruction authentication in which the addressee is requested to provide further pre-registered information, stored in the providers database, in response to instructions to transact or provide access to information, the further pre-registered information being required to be provided before the addressee's instructions are on forwarded for processing.

Preferably the steps of providing the information token to the provider's information system, providing log in details including at least the user ID and password of an addressee, providing access to the content, and receiving the addressee's instructions are all conducted during a secure mobile Internet session.

Preferably the step of providing the information token during a secure mobile Internet session comprises the addressee requesting a URL of a domain maintained by the provider, wherein the URL contains a unique alphanumeric string that comprises the information token.

In a further alternate embodiment of the invention there is provided a method for receiving an addressee's secure instructions, the method comprising:

an information system of a provider receiving a request;

the information system of the provider forwarding the request to the information management system of an operator;

the information management system of the operator generating an information token for use as first authentication means, and generating a content from the request, and storing the information token and the content in a database of the information management system;

the information management system of the operator sending a message to the addressee's registered Internet enabled mobile telephone containing the information token, an alert and an invitation to log into the information management system of the operator;

the addressee providing the information token to the information management system of the provider;

the information system of the provider authenticating the addressee by querying its database for instances of the information token, and if it is present, presenting the addressee with a login screen for the entry of second authorisation comprising the addressee's user ID and password;

the information management system of the operator granting the addressee access to the content if the information token provided in the previous step is associated with the at least the user ID, password and the content provided in the second step;

the information management system of the operator receiving the addressee's instructions provided and forwarding the instruction on to the information system of the provider for processing.

Preferably the request received by the information management system is a request to authorise a transaction or access to information in which the addressee is not physically present.

Preferably the information management system of the operator conducts post instruction authentication in which the addressee is requested to provide further pre-registered information, stored in the operator's database, in response to instructions to transact or provide access to information, the further pre-registered information being required to be provided before the addressee's instructions are on forwarded to the information system of the provider for processing.

Preferably the steps of providing the information token to the operator's information management system, providing log in details including at least the user ID and password of an addressee, providing access to the content, and receiving the addressee's instructions are all conducted during a secure mobile internet session.

Preferably the step of providing the information token during a secure mobile internet session can be carried out by requesting a URL of a domain maintained by the operator, wherein the URL contains an alphanumeric string that comprises the information token.

Preferably the secure wireless Internet session involves an encrypted WAP mediated exchange of WML information over the Internet.

Alternatively, the secure wireless Internet session involves an encrypted HTTP mediated exchange of HTML information over the Internet.

### BRIEF DESCRIPTION OF THE DRAWINGS

In order that the invention may be readily understood and put into practical effect, reference will now be made to the accompanying drawings depicting preferred embodiments of the invention in which:

FIG. 1 is a schematic of the major components of the system according to an aspect of the invention;

FIG. 2 is a flow chart showing preferred steps in the implementation of a method of practicing an aspect of the invention.

FIG. 3 is a screen shot of a step in the working of an embodiment of the invention;

FIG. 4 is a screen shot of a step in the working of an embodiment of the invention;

FIG. 5 is a screen shot of a step in the working of an embodiment of the invention;

FIG. 6 is a screen shot of a step in the working of an embodiment of the invention;

FIG. 7 is a screen shot of a step in the working of an embodiment of the invention;

FIG. 8 is a screen shot of a step in the working of an embodiment of the invention;

FIG. 9 is a screen shot of a step in the working of an embodiment of the invention;

FIG. 10 is a screen shot of a step in the working of an embodiment of the invention;

FIG. 11 is a screen shot of a step in the working of an embodiment of the invention;

FIG. 12 is a screen shot of a step in the working of an embodiment of the invention;

FIG. 13 is a screen shot of a step in the working of an embodiment of the invention;

FIG. 14 is a screen shot of a step in the working of an embodiment of the invention;

FIG. 15 is a screen shot of a step in the working of an embodiment of the invention;

FIG. 16 is a screen shot of a step in the working of an embodiment of the invention.

### MODES FOR CARRYING OUT THE INVENTION

The present invention allows an organisation such as a bank or credit card provider to obtain from its customer, confirmation that a requested transaction or request to access online banking services has indeed been requested by the customer and not some other unauthorised person.

The invention can be carried out by any one financial or similar institution, or the method can be performed by separate organisations acting in concert. Indeed, the method is quite flexible such that some or all of the steps in the method can be carried out by a financial institution.

The invention has been described with reference to its application in fraud control with respect to the conduct of transactions in which one party is not present. The present invention however, has application outside of this field. In particular it has application in any field in which organisations or individuals need to communicate with their customers or other registered users in order to securely inform them of information and receive their secure and confidential instructions in reply. Such systems may involve the receipt of instructions to transact, and in other cases, the instructions relate to availability and or other matters including interests.

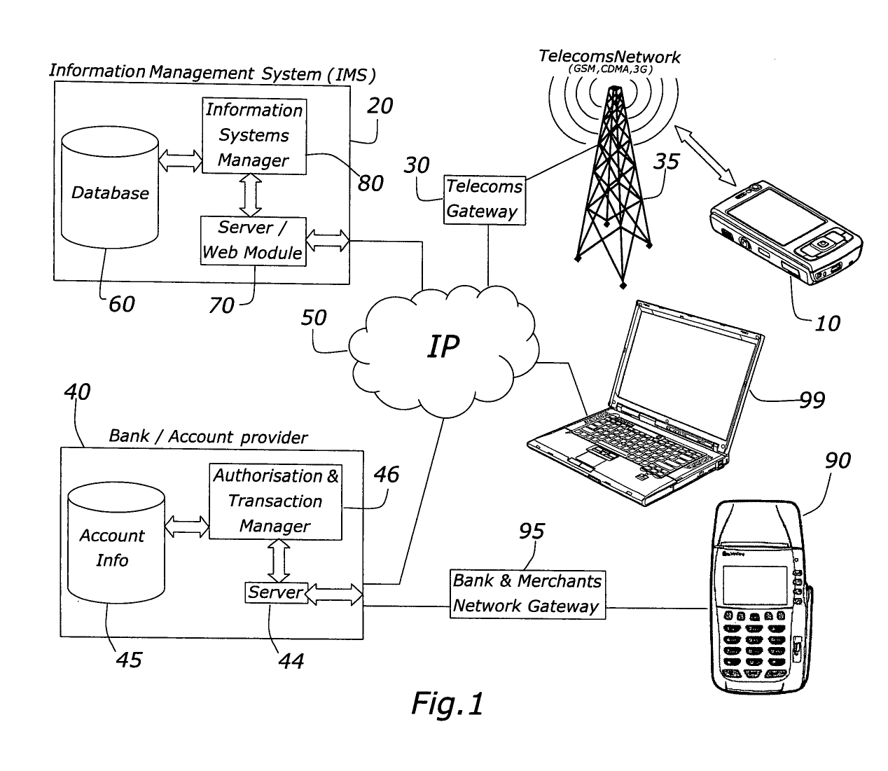

FIG. 1 depicts one embodiment of the invention in which the invention is carried out by two parties, the operator of the system, and the provider of the request. Other embodiments are possible, in particular where the method is carried out by a single party. Further, the embodiment described below is an embodiment in which the operator of the service sends out the invitation but also conducts the authentication, receives the instructions and forwards them on for processing. As the person skilled in the art would realise, it is possible for the operator of the service to just send out the message and have the authentication and receipt of instructions taken by the very organisation that would eventually need to process the instructions.

Turning back to the present embodiment in which the operator of the service sends out the invitation but also conducts the authentication, receives the instructions and forwards them on for processing, the components for carrying out the method are depicted in FIG. 1.

The first requirement is that the bank's customer needs an Internet enabled handheld device or mobile telephone (for example a 3G, GPRS equipped, or GSM based mobile telephone) with a WAP or other similar mobile Internet browser. The browser does not need to be a WAP browser, but indeed, any browser capable of rendering web pages on a mobile handheld device will be sufficient. These may include those that are capable of properly displaying XML, HTML, cHTML, xHTML and other web formats. The browser provided on the internet enabled handheld device or mobile telephone also needs to support standard 128 bit encryption via the Secure Sockets Layer (SSL) and Wireless Transport Layer Security (WTLS).

The handheld device or mobile telephone also needs a timely messaging capability such that the first message containing the invitation to log on can be provided in a timely fashion. This can be provided in normal digital telephones by the ubiquitous SMS capabilities provided by most mobile telephone companies and telecommunications carriers. Presently the format of this first message may be an SMS message with embedded URL links, or alternatively, a WAP push messages in the form of a systems indicator (SI) message. It may in the future be provided by handheld devices that support instant messaging or similar technologies that can be supported without installing third party software onto the device. The device does not need to be able to make standard audio telephone call as this function of the mobile telephone is not used.

These requirements do lend themselves to being found in Internet enabled mobile telephones and smartphones, but they may also found in other devices such as Nokia's Internet Tablets and some PDA's. Indeed, existing and future internet connected PDA's which connect to the internet through a telecommunications network may possess all of the features which would enable the present invention to be worked. These PDA's may receive short messages via SMS or instant messaging protocols, and thereafter are able to log into the information management system through a secure mobile internet session.

The person skilled in the art will appreciate that certain devices may in the future possess the required feature set and will therefore be able to be used. Such devices may include Internet enabled cameras, games machines, and portable media devices such as Apple Inc.'s iPod.

WAP (wireless application protocol) and WML (wireless markup language) are referred to throughout the specification. The person skilled in the art will appreciate that the reference to WAP and WML is not to be construed as a limitation but rather they have been used to describe generally the communications protocols utilised by wireless devices. As wireless devices become more sophisticated, their browsers and mark up language are becoming indistinguishable from those used on personal computers. WAP and WML are used to refer to the protocol and form of mark up language utilised by mobile telephones to access web pages during a browsing session. Their use includes standard web browsing now possible on mobile telephones such as Apple Inc.'s iPhone which browses HTML sites using a standard desktop browser, Safari.

The addressee's registered mobile telephone, 10, communicates with the Information Management System 20, via SMS through telecommunications gateway 30, and WAP or similar protocol through Internet 50. The information management system 20 communicates with the telecommunications gateway 30, and bank 40, through the Internet 50. Merchants, 90 are in turn connected to bank 40, through a gateway to the bank's and/or credit card provider's proprietary network. The information management system 20 is further comprised of database 60, server 70, and managing software 80. The bank's system is further comprised of account database 45, server 44, and authorisation and transaction manager 46.

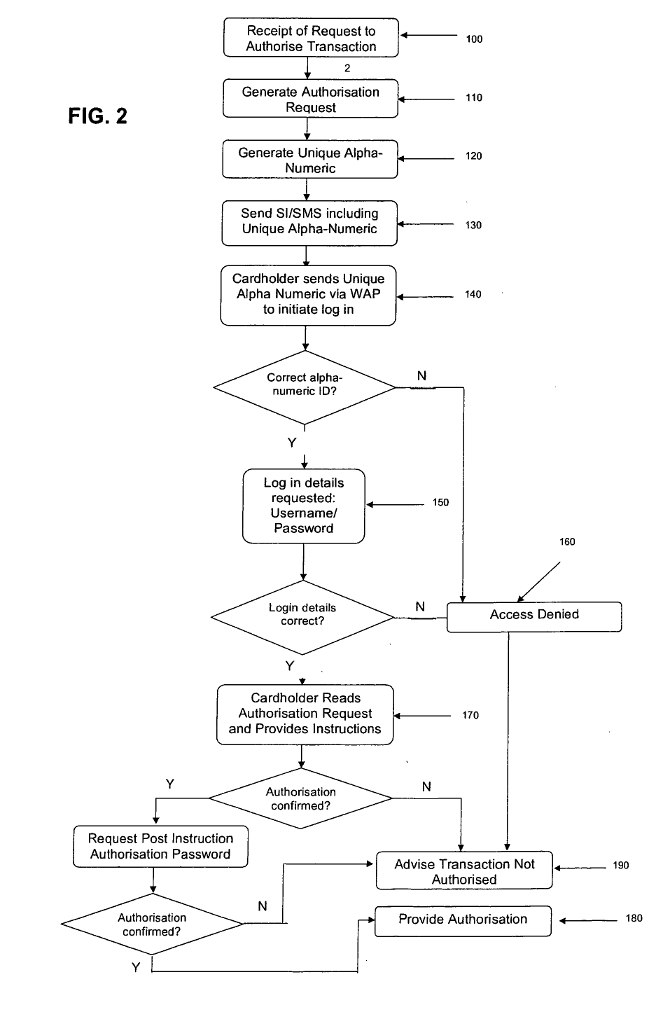

In the present embodiment, with separate operator of the service and provider, the steps of the method of the invention are set out in the flowchart contained in FIG. 2. Referring to FIGS. 1 and 2 the first step 100, in the method involves the receipt of a request to authorise by the information management system's server 70. The request would ordinarily originate from the bank or credit card provider's authorisation system 40, and specifically, server 44 connected to Internet 50 or otherwise connected to server 70 on a private IP network.

The request to authorise would itself, be generated in respect to a transaction sought to be conducted through the banks authorisation and transaction manager 46, bank network 95 and server 44. The request for authorisation generated by the bank system 40 is sent through Internet 50 or private IP network to server 70 and is ultimately received by information systems manager 80.

The authorisation requests contain certain details including, in most cases, the name of the merchant seeking to be paid and the amount sought to be transferred and the account that the money is proposed to be debited from.

Once the request is received by the information management system's server 70, it is transformed into a communication comprising an authorisation request, by the information system manager 80 during step 110. This step, in one embodiment of the invention, includes the information systems manager querying the database 60, for the registration details of the addressee the authorisation request was received in respect of. The registration details provide for the format communications with the addressee are to be in so that the first messages and dynamically generated HTML or WML pages are viewable by the addressee on their mobile telephone.

In alternate embodiments of the invention, the addressee's need not be pre-registered with the operator of the information management system 20 if the bank or other institution wishing to authorise a transaction or authorise access to information provides in its request, the details that the operator of the information management system 20 needs to send the message. Such details would include either the model number and brand name of the addressee's mobile telephone, or alternatively, information in respect of what format and protocol to use to send messages, the addressee's username and password that would need to be required to be provided to the information management system 20 in order to view the information, and the addressee's mobile telephone number.

In the next step 120 the information system manager 80 then generates a random, unique, alphanumeric string (the information token), which is associated with the authorisation request in the information management system's database 60. Each unique alphanumeric string is unique to an associated authorisation request. Therefore no one alphanumeric string will be associated with more than one authorisation request within the database. The string should be anywhere upwards of 6 alphanumeric characters, said length only being constrained by the limitations of the mobile phone (and associated messaging protocols).

The next step in the method involves the information systems manager 80 sending a first text message 130, via a telecommunications gateway 30, and telecommunications network 35 to mobile device 10. Generally two types of text message might be sent. SMS or short messaging service messages are short text messages able to be received by most if not all modern digital mobile telephone. However as there is the requirement that the addressee's mobile telephone be able to accept text messages with embedded URL's, some addressee's mobile telephones will be unable to display and subsequently act upon any selection of the embedded URL. Accordingly, if the model of phone used by the addressee is not capable of carrying out that function a SI or systems indicator is sent to the phone in a WAP session initiated by the information management system 20. Once received, the message is parsed by the phones firmware and a message extracted and is usually placed in the users service inbox as a text message with embedded URL.

Once the format the addressee needs to have text messages delivered in is determined by reference to stored registration details, or alternatively, as provided in the authorisation request, the information system manager 80 then generates the first message which contains both the unique alphanumeric string in the embedded URL that directs the addressee's mobile Internet browser (such as, for example, a WAP, cHTML, XML, HTML or xHTML browser) to request web pages maintained on an IP domain managed by the information system manager 80 and server 70. Further the first message will generally provide for details of the provider of the first message but will not provide details of the authorisation request.

The addressee then sends the unique alphanumeric to the provider to initiate the log in, during step 140. In this embodiment of the invention, the unique alphanumeric string forms part of the URL provided to the addressee in the first SMS (or SI) message. In this manner, the addressee can provide the unique alphanumeric string by simply selecting the URL for a WML page to be requested in the mobile phone's WAP or other Internet browser.

In particular the selection of the URL causes the addressee's mobile Internet browser to send a WAP or other similar web protocol request for a valid and existing WML or similar web page with the alphanumeric appended to the end as a variable. When the server 70, receives the request, it retrieves the WML page specified in the request, and extracts the variable containing the unique alphanumeric string. Once the correct alphanumeric code has been obtained, the information systems manager 80 takes it and uses it to query the database 60 for any authorisation requests associated with it.

If the unique alphanumeric string found within the URL does not match any contained within the database or alternatively if no alphanumeric is obtained at all from the request then the information management system denies the addressee access to the system, 160. This denial of access occurs before the addressee has the ability to enter any user ID or password.

If the information systems manager 80 discovers the unique alphanumeric string in the database in association with an authorisation request, the information system manager will further interrogate the database to determine which addressee's are authorised to see the associated authorisation request. Once it establishes the identity of the addressee's that are authorised to see the authorisation request, a secure mobile internet session is opened on the mobile phone browser. The session is secured with 128-bit encryption via the Secure Sockets Layer (SSL) between the application server and the WAP gateway, and Wireless Transport Layer Security (WTLS) between the WAP gateway and the mobile phone browser. The encryption is present throughout the entire time the user is logged on.

Once the secured and encrypted session is established the information systems manager 80, will then, at step 150, cause the server 70, to provide a properly formatted web page, viewable by the users mobile telephone Internet browser, said page requesting the addressee to provide log in details to the information management system 20. Such login details would usually include user ID's and passwords chosen by the addressees or provider at the time of registration of the addressee in the operator's database 60.

The WML information provided, that once rendered on screen, requests the login details of the addressee, is communicated to the addressee through the telecommunications network 35 and Internet 50, during a secure or encrypted WAP or similar mobile Internet browsing session. If the user ID and password provided by the addressee are also contained within database 60 and further, are in association with an authorisation request identified by the information systems manager 80 in the previous step, then access is granted at step 170 to the information management system 20, and in particular, providing the addressee access to the content generated in response to the authorisation request. It is at this point that details of the proposed transaction or authorisation to access account information are provided to the addressee. Further it is at this point that the addressee can authorise the proposed transaction at step 180, or advise that authorisation is not provided, 190. In either case the response is received by the information systems manager 80 via server 70 which then communicates to the banks system 40, which originally requested the authorisation and instructs the authorisation manager 46, to either conduct the transaction or advise that the transaction is not authorised.

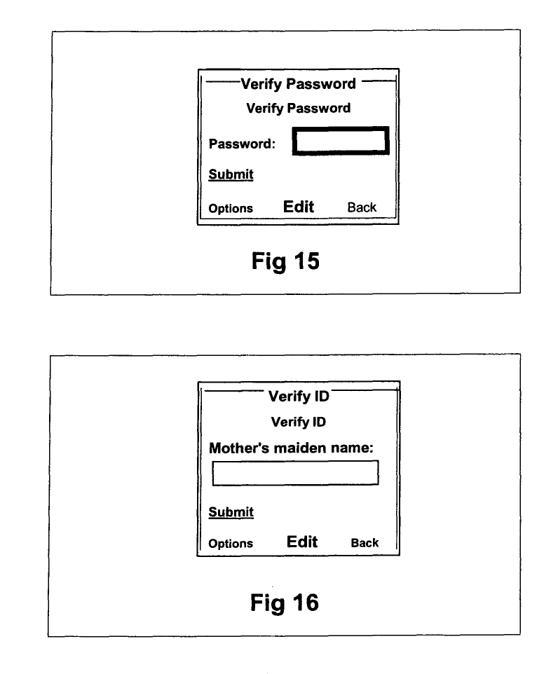

In an alternate embodiment of the invention, if the addressee provides instructions to conduct the transaction or provide access this instruction is not acted upon or forwarded for actioning until a further round of authentication is successfully completed. In the present embodiment of the invention the further round of authentication is carried out by requesting the provision of pre-registered information known only to the addressee. It may even be as simple as re-requesting the entering of the password entered previously as indicated in FIG. 15, or mothers maiden name as in FIG. 16. Unless this third level of authentication is passed, the instruction provided to conduct the transaction or provide access is not acted upon or forwarded for processing.

The embodiment of the invention described above provides for increased security over conventional methods in a number of ways. In particular, even if a person intending on committing a fraudulent transaction has the addressee's username and password to the information management system they will not be able to log in and effect the transaction without first providing the unique alphanumeric string which is sent to the addressee's mobile telephone in the first message.

Further, the information systems manager 80, of the information management system 20, can be instructed to only grant access to the information management system only once in response to the provision of a correct unique alphanumeric string. Thus if an addressee uses a URL embedded in a first message to attempt to gain access through the provision of a WAP or similar request containing the unique alphanumeric string (in the URL of the request), the same URL contained in the first message will not grant access to the system in future attempts at logging in if the addressee has already logged in once using the URL, or alternatively, after a certain period of time has expired as explained in more detail below.

In cases such as credit card transactions, to defraud this system, it would be necessary to obtain the correct credit card details, obtain the card holder's phone to receive the first message or guess correctly the URL, including the alpha-numeric ID (of which there are roughly 2,176,782,336 possible combinations), and obtain the card holder's username, password and post instruction authentication password (such as mothers maiden name) for the information management system to complete the transaction.

A further improvement to the security of the system for conducting and authorising transactions is the ability for the alphanumeric to time out and become inactive, even if it is not provided by the addressee. The alphanumeric codes can be made set to expire at any period of time, but would generally be in the order of minutes or hours and not days.

The system and methods of the present invention are explained in greater detail with reference to FIG. 1. Where the operator's information management system 20 is used to record and store addressee's details, these may be stored, for example, in the operator's database 60. The operator's server 70, is connected to the Internet 50, and is thereby adapted to receive information from any number of public or proprietary sources. One of these sources may be a credit card processing system owned by a bank.

As further shown in FIG. 1, the bank system 40 which interfaces with the operators system 20, through Internet 50, comprises a server 44, authorisation and transaction manager 46, and account database 45. Database 60 is adapted to record, store and maintain addressee information required by the provider, and is capable of providing all the provider's information needs with respect to its addressees but is not capable of actually performing transactions.

In a further aspect of the invention the request for authorisation can be created manually by the user of a computer 99, connected to the Internet 50. Equally, the computer may be connected via a private IP connection to server 70, or server 44. Indeed, Server 70 and server 44 may themselves be connected by a private IP connection, or indeed, their functions could be merged in an integrated embodiment of the invention wherein the authorisations and completion of transactions occur in the one system.

In a further embodiment of the invention, the request to provide instructions can be generated manually. In this embodiment the user of computer 99, logs into the information management system 20 wherein the server 70, presents the user with a form through which the user may access a list of addressees, whether this list is provided by the database 60 or database 45. The user uses this list to generate a request for a unicast, multicast or broadcast of messages to individual addressees. Whether stored remotely or locally, the list is protected by security features which prevent tampering or abuse. The form presented to the provider is preformatted to suit his individual needs and may be provided in the form of an Internet aware application for running in various operating systems and environments, including a Java environment, or it may be provided through a web page accessible over Internet 50.

In either case the user completes the empty fields in the form and sends the unicast, multicast or broadcast request through the Internet 50 to the server 70. The information systems manager 80 converts the provider's HTML request to a web format appropriate for viewing by the addressee's particular mobile phone, for example, WML, HTML, cHTML, xHTML or XML. Communication with the addressees occurs through a suitable telecommunications gateway 30. It will be understood that the gateway 30 could be, for example, an SMSC gateway, a CSIM gateway or a GPRS gateway.

Instructions sent by the addressee through their mobile telephone are delivered through the telecommunications network 35, and passes through the gateway 30, back through to the server 70, of the information management system 20.

In a further preferred embodiment of the invention, the messages and instructions sent and received between operator of the information management system 20 and addressee are date and time stamped and are stored in a secure fashion such that they cannot be altered, edited or amended. This provides an auditable record of the transactions between the operator and the addressee.

In other embodiments of the invention an operator of the information management system 20 may forward more complete messages in the form of, for example, video footage, audio files, audio-visual materials, charts or graphs or text messages to be forwarded to a client's e-mail address or post office box if not displayable on the addressee's mobile telephone.

It will be appreciated that the system of the present invention operates independent of any particular carrier or brand of telecommunications device. The methods and practices of the present invention are also independent of any particular telecommunications protocol (eg GSM, CDMA, TDMA, GPRS, HSPDA, UMTS, EDGE).

In other preferred embodiments, messages which are sent and received, even when they are stored in the information management system database 60 are not able to be reviewed or read by the operators of the information management system 20. The owners or operators of the information management system 20 may be able to review, for statistical or billing purposes, the number of messages sent and percentage of responses received but are actually able to review the contents of individual messages. In preferred embodiments, the bank or other organisation sending the requests for authorisation is billed according to the number of requests placed through the system.

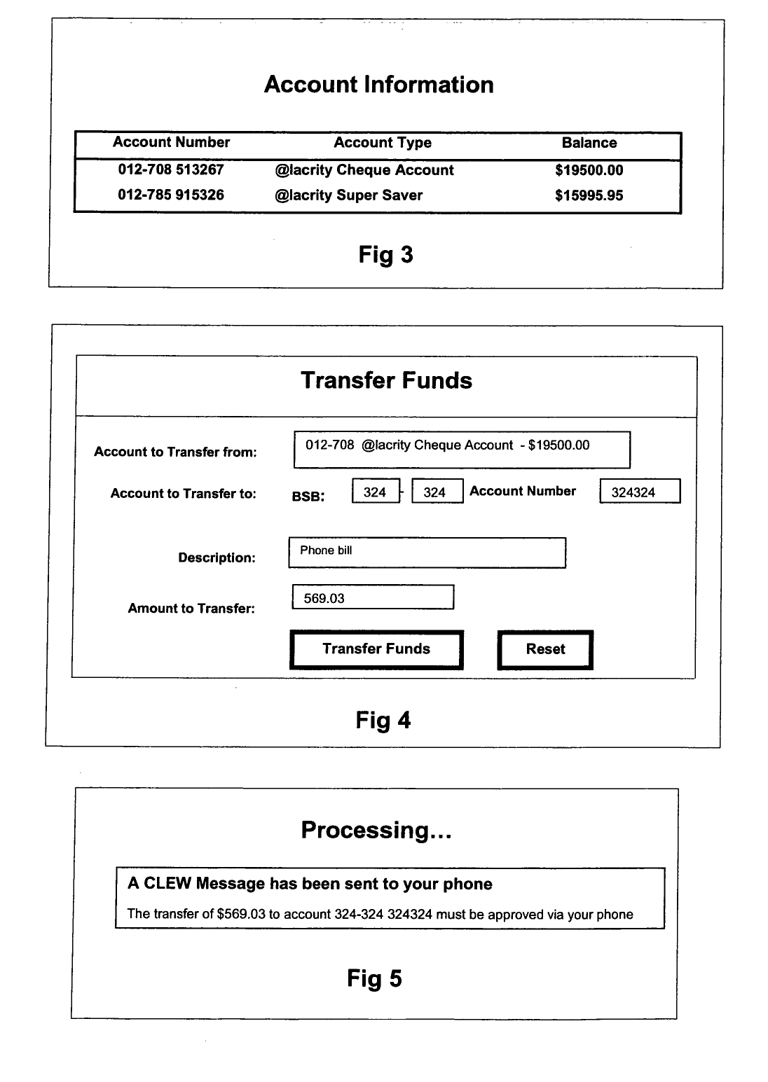

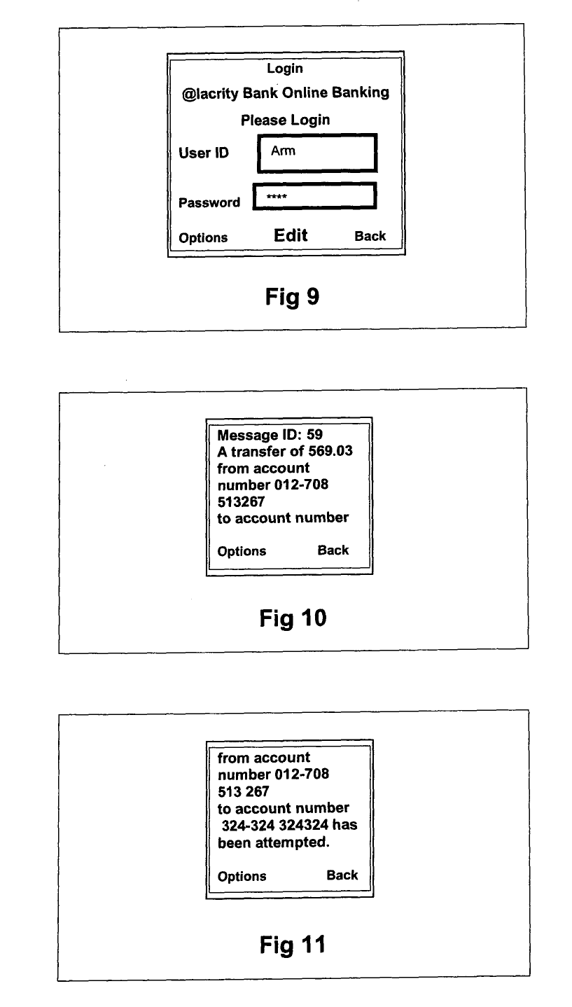

FIGS. 3-16 show the various steps of the method of the present invention from the point of view of the addressee in the context of an online banking transaction.

FIG. 3 depicts the account information of the addressee's accounts maintained with the fictitious Alacrity Bank. FIG. 4 depicts the user of the online banking site requesting to make a transfer. FIG. 5 indicates to the user that the first message has been sent to the addressee's mobile telephone.

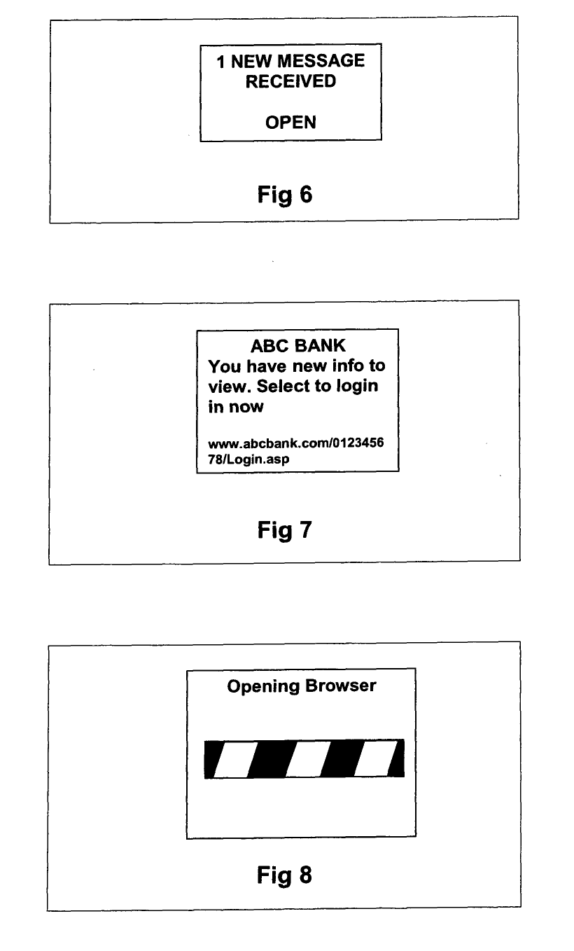

FIG. 6 shows the receipt of the first text message containing the invitation to log into the information management system 20 as depicted in FIG. 7. Upon selecting the embedded URL the addressee's mobile Internet browser is activated as depicted in FIG. 8 where at that time a web page is being requested from the Internet 50. If the alphanumeric embedded in the URL is recorded in the database 60 and has not yet been used or has not yet expired, then the information management system 20 provides a web page to the addressee's telephone browser requesting the input of a user ID and password.

FIGS. 10 and 11 show the mobile Internet browser displaying the authorisation request containing details of the transaction sought to be authorised.

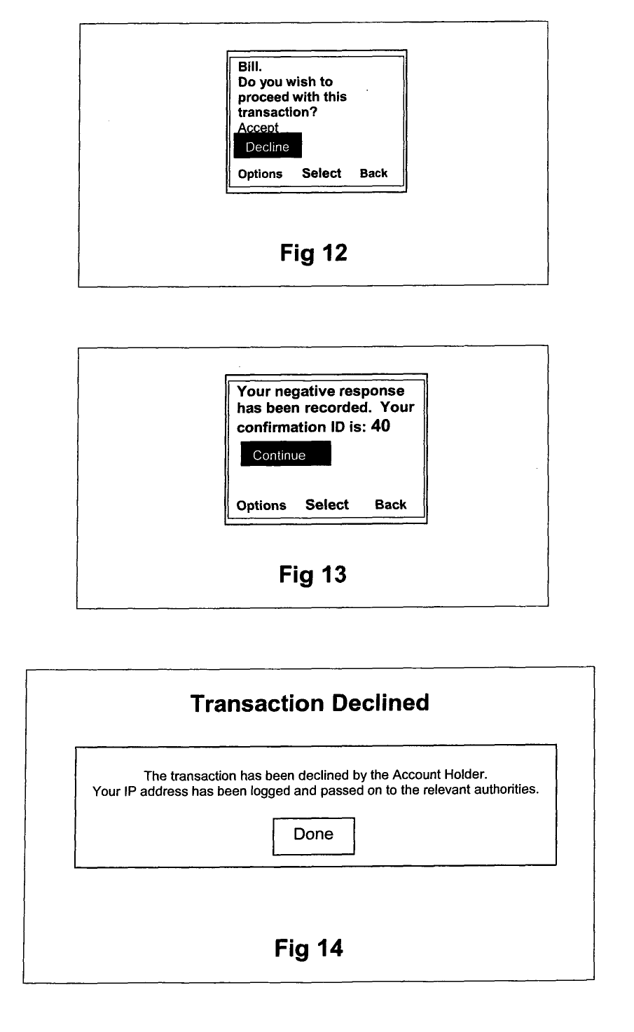

FIG. 12 shows the bottom of the authorisation request WML page which has links which can be selected by the addressee to either authorise the transaction or decline it.

FIG. 13 depicts the response forwarded by the information management system 20 in response to the instruction provided by the addressee.

FIG. 14 shows the screen of the Internet banking web site after the transaction was declined by the addressee through their mobile telephone.

FIGS. 15 and 16 depict post instruction authorisation requests made by the information management system 20 after a positive instruction is received according to one aspect of the invention. This provides a further layer of security with the addressee being asked to provide pre-registered information so as to confirm identity of the user of the mobile telephone.

Numerous modifications and alterations may be devised by those skilled in the art without departing from the spirit and scope of the present invention. Thus whilst the present invention has been described above with particularity and detail, it will be apparent to those of ordinary skill in the art that numerous modifications, including but not limited to, size, materials, shape, form, function, and manner of operation may be made without departing from the scope or ambit of the invention.

1. A secure information management system for accessing sensitive information and conducting transactions comprising a data store and information systems manager connected to the Internet and a telecommunications network via an Internet server and telecommunications gateway, the information management system being adapted to:
receive an authorisation request,
prepare content containing details of the authorisation request,
generate an information token and store it in association with the content and a list of addressee's entitled to view the content,
send a first message to the addressee's mobile telephone containing the information token and invitation to log into the information management system for access to the content,
receive from the addressee's mobile telephone the information token and request to log into the information management system during a secure wireless Internet session,
authenticate the addressee based on the provision of the information token recorded in the database and associated with the content,
provide access to a log in screen to the addressee during a secure wireless Internet session,
authenticate the addressee on the log in details provided, and
if the log in details match those contained in the database in association with the information token and the content, provide the addressee with the content, and
receive from the addressee's mobile telephone, instructions sent by the addressee during the secure wireless Internet session.

2. An information management system according to claim 1 which is adapted to forward the addressee's instruction for processing.

3. An information management system according to claim 1 which is capable of requesting the addressee to provide further pre-registered information in response to instructions to transact or provide access to information, the further pre-registered information being required to be provided before the addressee's instructions are forwarded for processing.

4. An information management system according to claim 1 which is capable of processing the addressee's instructions.

5. An information management system according to claim 1 wherein a secure mobile Internet session involves an encrypted WAP mediated exchange of WML information over the Internet.

6. An information management system according to claim 1 wherein a secure mobile Internet session involves an encrypted HTTP mediated exchange of HTML information over the Internet.

7. A method for receiving addressee's secure instructions, the method comprising:
an information management system receiving a request;
the information management system creating a content for storage in a database of the information management system relating to the request and containing a request to provide instructions;
the information management system creating an information token to be associated with the content for use as first authentication means, and with the addressee's pre-registered user ID and password for use as a second authentication means;
the information management system sending a message to the addressee's registered Internet enabled mobile telephone containing the information token, an alert and an invitation to log into the information management system;
the addressee initiating a secure wireless Internet session and providing therein, at least, the information token;
the information management system authenticating the addressee by querying the database for instances of the information token, and if it is present, presenting the addressee with a login screen for the entry of a user ID and password;
the information management system providing the addressee access to the content during the secure wireless Internet session if the information token provided in the previous step is associated with the at least user ID, password and the content contained in the database;
the information management system receiving the addressee's instructions provided during the secure wireless Internet session and forwarding the instruction for processing.

8. A method for receiving addressee's secure instructions according to claim 7 wherein a secure mobile Internet session involves an encrypted WAP mediated exchange of WML information over the Internet.

9. A method for receiving addressee's secure instructions according to claim 7 wherein a secure mobile Internet session involves an encrypted HTTP mediated exchange of HTML information over the Internet.

10. A method according to claim 7 wherein the request received by the information management system is a request to authorise a transaction or access to information in which the addressee is not physically present.

11. A method according to claim 7 wherein the information management system conducts post instruction authentication in which the addressee is requested to provide further pre-registered information, stored in its database, in response to instructions to transact or provide access to information, the further pre-registered information being required to be provide before the addressee's instructions are acted upon.

12. A method according to claim 7 wherein the invitation to log into the information management system is contained within a first text message to the mobile telephone.

13. A method according to claim 12 wherein the first text message sent to the addressee's mobile telephone comprises a SMS or SI with embedded URL.

14. A method according to claim 13 wherein the URL is embedded in the SMS or SI message such that the user does not have to re-enter the URL in the mobile telephones Internet browser in order to log on to the information management system.

15. A method according to claim 7 wherein the information token is a unique alphanumeric string included in the SMS or SI that contains the invitation to log in and the URL.

16. A method according to claim 15 wherein the alphanumeric string is contained within the URL such that when the URL is selected by the addressee the request to log in sent out to the information management system by the mobile telephone's mobile Internet browser includes the unique alphanumeric string.

17. A method according to claim 16 wherein the alphanumeric string generated by the information management system can only be used as an authentication means only once and can be made to expire even before it has been used once if a certain period of time has elapsed.

18. A method according to claim 7 wherein the step of on forwarding the addressee's instruction for processing includes the information management system providing the system which originally requested the transaction or access authorised with the instruction to either accept or decline the transaction or access.

19. A method according to claim 7 wherein the steps of receiving from the addressee a URL request to log into the information management system containing the unique alphanumeric string, requesting at least a username and password from the one or more addressees, providing access to the content, and receiving the addressee's instructions all occur during a secure wireless Internet session initiated by the addressee through their mobile telephone.

20. A method according to claim 7 wherein the steps of receiving the request is carried out by the information management system by:
forwarding a form to a provider over the Internet, the form having fields for the provider to indicate at least an addressee and a content relating to the event or transaction requiring authorisation;
the information management system being adapted to receive the form completed by the provider, create the content and store it in the information management systems database, and send the first message to the addressee containing the alert, the information token, and the invitation to log into the information management system.

21. A method according to claim 20 wherein the form is provided in a web page accessible by standard web browsers over the Internet.

22. A method according to claim 7 wherein the content and first message are dynamically constructed by the information management system without further human intervention in response to the receipt of the request containing details of the event or transaction requiring authorisation.

23. A method according to claim 7 wherein the information management system may provide for a window of time in which the one or more addressee's can access the content.

24. A method according to claim 7 wherein the information management system may provide a certain number of times in which the one or more addressee's can access the content.

25. A method according to claim 7 wherein the information management system may provide that the one or more addressee's can access the content only once.

26. A method according to claim 7 wherein the wireless device is a mobile telephone with at least SMS/SI capabilities and WAP/HTML browser capabilities.

27. A method according to claim 7 wherein the first message contains an embedded URL which directs the recipient of the message to the login screen to the information management system.

28. A method according to claim 7 wherein the information management system automatically generates content for an addressee in response to the information received by systems connected to the information management system containing requests to process and authorise cardholder not present transactions or other online transactions occurring in which case one party in not present.

29. A method according to claim 7 wherein the content automatically generated in response to information received by systems connected to the information management system containing requests to process and authorise cardholder not present transactions or other online transactions occurring in which case one party is not present includes details of the requested transaction and a request to provide instructions whether to proceed with the transaction, said instructions being provided during a secure mobile Internet browser session, and where the information management system manager routes the instruction back to the system connected to the information management system for processing.

30. A method for receiving an addressee's secure instructions, the methods comprising:
an information system of a provider receiving a request;
the information system of the provider storing the request in a database under the control of the information system;
the information system of the provider forwarding the request to the information management system of an operator which uses it to generate a content;
the information management system of the operator generating an information token for use as first authentication means as associating it with the content;
the information management system of the operator sending a message to the addressee's registered Internet enabled mobile telephone containing the information token, an alert and an invitation to log into the information system of the provider to access the content;
the information management system of the operator sending the information token to the provider along with details of the message sent to the addressee;
the information manager of the provider recording the information token and other details in its database in association with the request.
the addressee providing the information token to the information system of the provider;
the information system of the provider authenticating the addressee by querying the database for instances of the information token, and if it is present, presenting the addressee with a login screen for the entry of second authorisation means which include, at least, a user ID and password;
the information system of the provider granting the addressee access to the content if the information token provided in the previous step is associated with the at least user ID, password and the content provided in the second step;
the information system of the provider receiving the addressee's instructions provided.

31. The method according to claim 29 where the information system of the provider receiving the addressee's instructions also carries out the instructions.

32. A method according to claim 30 wherein the request received by the information management system is a request to authorise a transaction or access to information in which the addressee is not physically present.

33. A method according to claim 30 wherein the information system of the provider conducts post instruction authentication in which the addressee is requested to provide further pre-registered information, stored in the providers database, in response to instructions to transact or provide access to information, the further pre-registered information being required to be provided before the addressee's instructions are processed.

34. A method according to claim 33 wherein the steps of providing the information token to the providers information system, providing log in details including at least the user ID and password of an addressee, providing access to the content, and receiving the addressee's instructions are all conducted during a secure mobile Internet session.

35. A method according to claim 34 wherein a secure mobile Internet session involves an encrypted WAP mediated exchange of WML information over the Internet.

36. A method according to claim 34 a wherein a secure mobile Internet session involves an encrypted HTTP mediated exchange of HTML information over the Internet.

37. A method according to claim 33 wherein the step of providing the information token during a secure mobile Internet session can be carried out by requesting a URL of a domain maintained by the provider, wherein the URL contains a unique alphanumeric string that is the information token.

38. A method for receiving addressee's secure instructions, the method comprising:
an information system of a provider receiving a request;
the information system of the provider forwarding the request to the information management system of an operator;
the information management system of the operator generating an information token for use as first authentication means, and generating a content from the request, and storing the associated information token and the content in a database of the information management system;
the information management system of the operator sending a message to the addressee's registered Internet enabled mobile telephone containing the information token, an alert and an invitation to log into the information management system of the operator;
the addressee providing the information token to the information management system of the provider;
the information system of the provider authenticating the addressee by querying its database for instances of the information token, and if it is present, presenting the addressee with a login screen for the entry of second authorisation means include, at least, a user ID and password;
the information management system of the operator granting the addressee access to the content if the information token provided in the previous step is associated with the at least the user ID, password and the content provided in the second step;
the information management system of the operator receiving the addressee's instructions provided and forwarding the instruction on to the information system of the provider for processing.

39. A method according to claim 38 wherein the request received by the information management system is a request to authorise a transaction or access to information in which the addressee is not physically present.

40. A method according to claim 39 wherein the information management system of the operator conducts post instruction authentication in which the addressee is requested to provide further pre-registered information, stored in the providers database, in response to instructions to transact or provide access to information, the further pre-registered information being required to be provided before the addressee's instructions are on forwarded to the information system of the provider for processing.

41. A method according to claim 39 wherein the steps of providing the information token to the operator's information management system, providing log in details including at least the user ID and password of an addressee, providing access to the content, and receiving the addressee's instructions are all conducted during a secure mobile Internet session.

42. A method according to claim 41 wherein a secure mobile Internet session involves an encrypted WAP mediated exchange of WML information over the Internet.

43. A method according to claim 41 a wherein a secure mobile Internet session involves an encrypted HTTP mediated exchange of HTML information over the Internet.

44. A method according to claim 39 wherein the step of providing the information token during the mobile Internet session can be carried out by requesting a URL of a domain maintained by the operator, wherein the URL contains a unique alphanumeric string that comprises the information token.
